(19) United States
(12) Patent Application Publication
(10) Pub. No.: US 2024/0170696 A1
(43) Pub. Date: May 23, 2024

(54) RADIAL MIXING MANIFOLD

(71) Applicant: ESS TECH, INC., Wilsonville, OR (US)

(72) Inventor: Joseph M. Cooley, Beaverton, OR (US)

(21) Appl. No.: 18/496,627

(22) Filed: Oct. 27, 2023

Related U.S. Application Data
(60) Provisional application No. 63/384,906, filed on Nov. 23, 2022.

(51) Int. Cl. H01M 8/04276; H01M 8/18

(52) U.S. Cl. CPC H01M 8/04276; H01M 8/188

(57) ABSTRACT

Systems and methods are provided for a redox flow batter system comprising a cylindrical electrolyte chamber fluidly coupled to a redox flow battery cell and at least one radial mixing manifold fluidly coupled to the cylindrical electrolyte chamber. The radial mixing manifold includes a flange configured to receive electrolyte from the redox flow battery cell and a manifold configured to mix and distribute the electrolyte within the cylindrical electrolyte chamber. The manifold includes a plurality of openings, at least one of which is a bottom opening, and extends from a first inner edge of the cylindrical electrolyte chamber to a second inner edge, lower than the first inner edge, of the cylindrical electrolyte chamber.

### CROSS REFERENCE TO RELATED APPLICATIONS

The present application claims priority to U.S. Provisional Application No. 63/384,906 entitled “RADIAL MIXING MANIFOLD” filed Nov. 23, 2022. The entire contents of the above identified application are hereby incorporated by reference for all purposes.

### FIELD

The present description relates generally to systems and method for mixing liquids in a liquid tank.

### BACKGROUND AND SUMMARY

Redox flow batteries are suitable for grid-scale storage applications due to their capability for scaling power and capacity independently, as well as for charging and discharging over thousands of cycles with reduced performance losses in comparison to conventional battery technologies. Capacity of a redox flow battery may be determined by an amount of available active species in an electrolyte. In many examples, electrolyte is stored in a tank, flowed through the redox flow battery cell where the electrolyte ions are at least partially reduced or oxidized, and then returned to the tank. It is desirable to effectively mix the returned electrolyte with the electrolyte in the tank. In this way, reduced and oxidized species within the electrolyte may be randomly distributed within the electrolyte tank to maintain proper performance of the redox flow battery.

Electrolyte in an electrolyte tank may be mixed by addition of a mechanical stirrer to the tank which may be energized to agitate the electrolyte. However, such a mechanical stirrer may demand additional power which may be parasitic to the power being stored or delivered by the redox flow battery system. Alternatively, passive mixing may be achieved through a return entering the electrolyte tank radially (e.g., perpendicular to a top surface of the electrolyte tank) and splitting in a T-junction to a manifold positioned axially (e.g., parallel to a bottom surface of the electrolyte tank) and including a plurality of openings thereby distributing electrolyte horizontally through the electrolyte tank as the electrolyte returns.

However, the inventors herein have recognized issues with the above axially positioned manifold. As one example, the T-junction demanded by the axially positioned return manifold may be constructed of a polyvinyl chloride (PVC) plastic which may be difficult to bond to a fiberglass wall of the electrolyte tank. Additionally, the T-junction may increase a friction experienced by the pumped electrolyte (e.g., pipe loss) which may result in increased power demand of the electrolyte circulation pumps. Further, the axially positioned manifold may not be able to mix electrolyte until an electrolyte level is above a threshold level, thereby submerging the axially positioned electrolyte. Still further, the axially positioned manifold may not be adequately supported by the electrolyte tank and may become cantilevered.

In one example, the issues described above may be at least partially addressed by a redox flow battery system including, a cylindrical electrolyte chamber fluidly coupled to a redox flow battery cell, at least one radial mixing manifold fluidly coupled to the cylindrical electrolyte chamber and including a flange configured to receive electrolyte from the redox flow battery cell and a manifold configured to mix and distribute electrolyte within the cylindrical chamber, and wherein the manifold extends from a first inner edge of the cylindrical electrolyte chamber to a second inner edge of the cylindrical electrolyte chamber, wherein the second inner edge is lower than the first inner edge, and wherein the manifold includes a plurality of openings and at least one bottom positioned at the second inner edge. In this way, a T-junction may be avoided and the manifold may be formed of a more desirable material than PVC. Additionally, the manifold may be supported by a bottom of the electrolyte tank. Further, pipe loss within the manifold may be reduced and a threshold level for mixing electrolyte may be decreased.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of an example redox flow battery system including an electrolyte tank and radial mixing manifold.

FIG. 2 shows a cutaway view of a multi-chambered electrolyte storage tank including a radial mixing manifold.

FIG. 3 shows a side view of a bottom of the multi-chambered electrolyte storage tank and a bottom of the radial mixing manifold.

FIG. 4 shows a flow chart of an example of a method for distributing electrolyte using the radial mixing manifold.

FIG. 5 shows a cross-sectional view of an embodiment of the radial mixing manifold including nozzles.

FIG. 6 shows a cutaway view of the multi-chambered electrolyte storage tank including an alternate embodiment of the radial mixing manifold.

### DETAILED DESCRIPTION

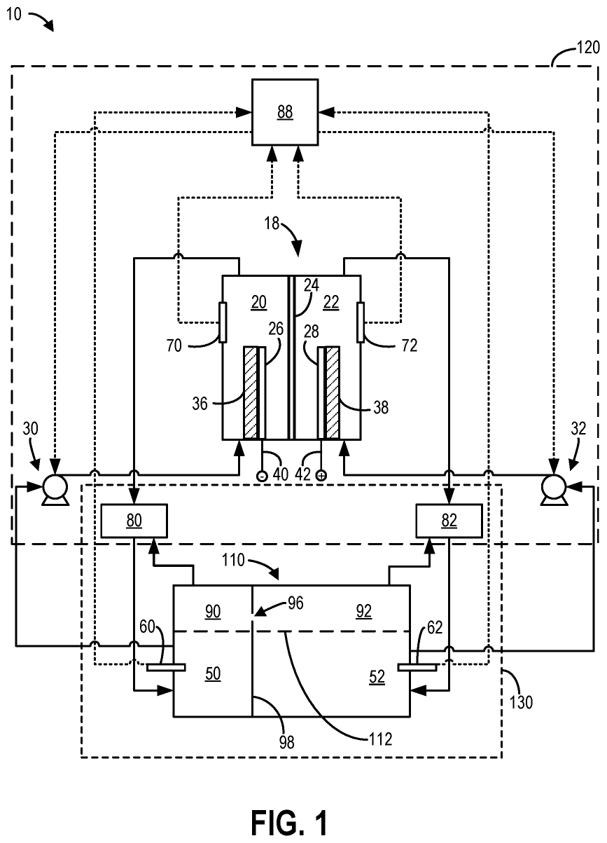

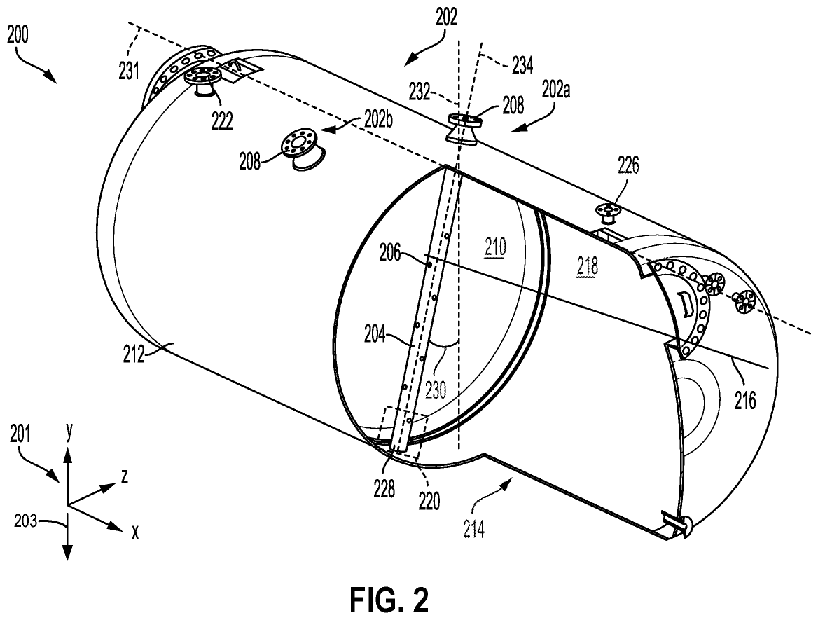

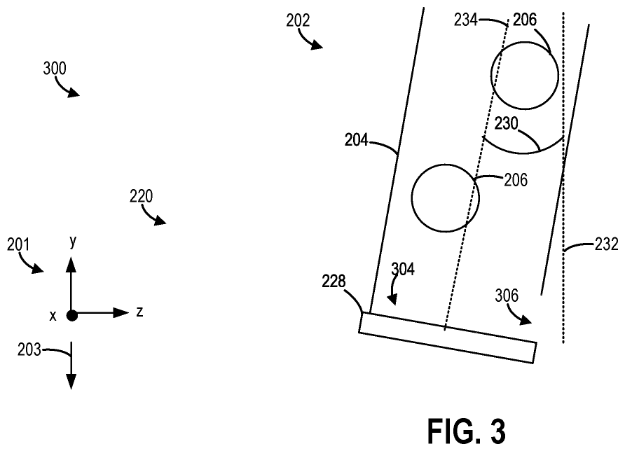

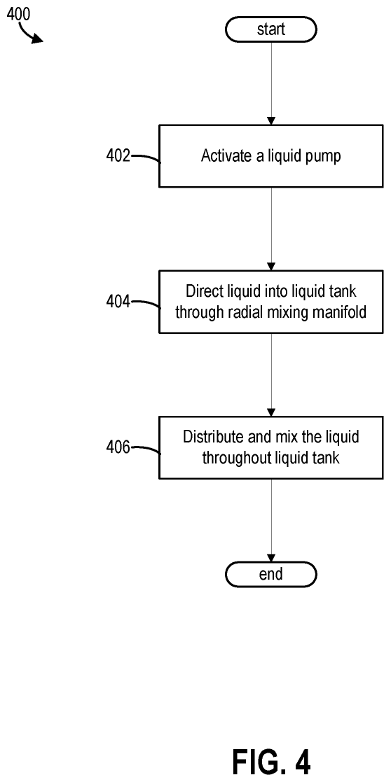

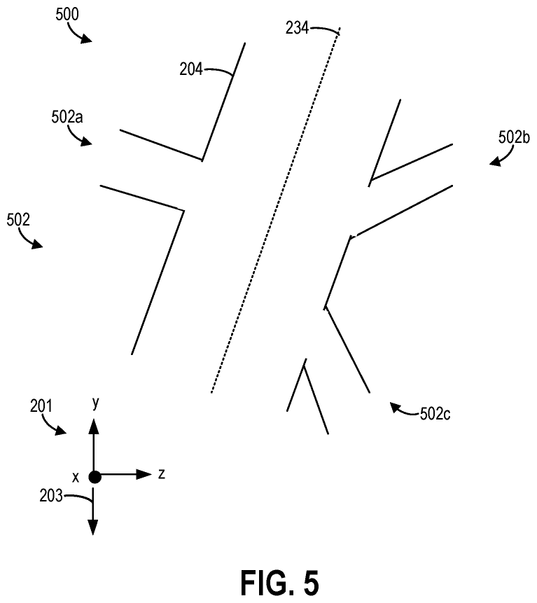

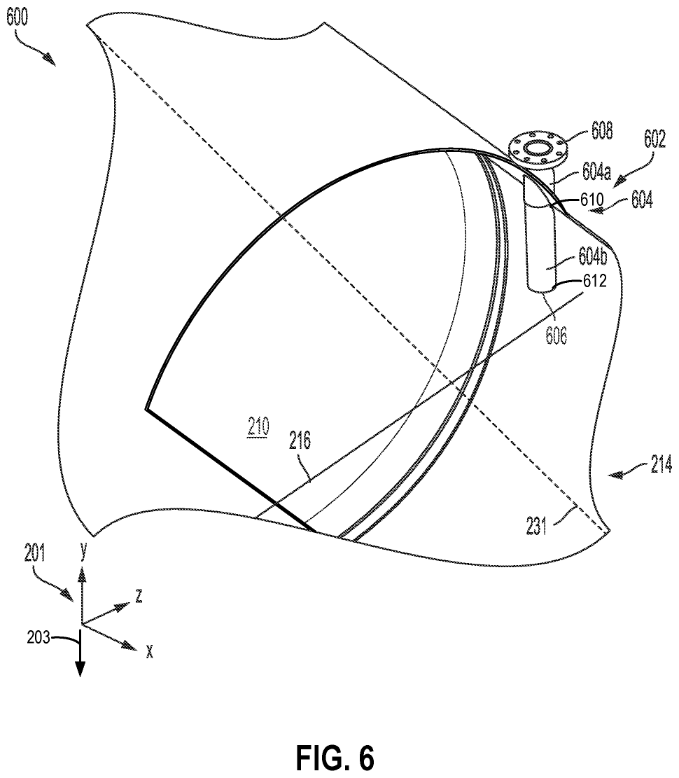

The following description relates to systems and method for a radial mixing manifold. Herein, a radial mixing manifold may refer to a manifold extending perpendicular from a top of a liquid tank. In a non-limiting example, the radial mixing manifold may be positioned at least partially within a cylindrical electrolyte chamber of a redox flow battery system such as the redox flow battery system described in FIG. 1. The cylindrical electrolyte chamber may be a multi-chambered electrolyte storage tank such as the multi-chambered electrolyte chamber shown in FIG. 2. The radial mixing manifold may include a flange for receiving electrolyte and a manifold including openings positioned within the cylindrical electrolyte chamber. The manifold may further include a bottom opening shown in detail in FIG. 3. In some embodiments, the openings of the manifold may include nozzles as shown in the cross-sectional view in FIG. 5. In an alternate embodiment, the radial mixing manifold may be positioned tangential to a wall of the multi-chambered electrolyte chamber as shown in FIG. 6 and flow of electrolyte along the sidewalls of the multi-chambered electrolyte chamber may cause mixing of the electrolyte. An example of a method for mixing and distributing electrolyte within a cylindrical electrolyte chamber using the radial mixing manifold is shown in FIG. 4.

As shown in FIG. 1, in a redox flow battery system 10, a negative electrode 26 may be referred to as a plating electrode and a positive electrode 28 may be referred to as a redox electrode. A negative electrolyte within a plating side (e.g., a negative electrode compartment 20) of a redox flow battery cell 18 may be referred to as a plating electrolyte, and a positive electrolyte on a redox side (e.g., a positive electrode compartment 22) of the redox flow battery cell 18 may be referred to as a redox electrolyte.

“Anode” refers to an electrode where electroactive material loses electrons and “cathode” refers to an electrode where electroactive material gains electrons. During battery charge, the negative electrolyte gains electrons at the negative electrode 26, and the negative electrode 26 is the cathode of the electrochemical reaction. During battery discharge, the negative electrolyte loses electrons, and the negative electrode 26 is the anode of the electrochemical reaction. Alternatively, during battery discharge, the negative electrolyte and the negative electrode 26 may be respectively referred to as an anolyte and the anode of the electrochemical reaction, while the positive electrolyte and the positive electrode 28 may be respectively referred to as a catholyte and the cathode of the electrochemical reaction. During battery charge, the negative electrolyte and the negative electrode 26 may be respectively referred to as the catholyte and the cathode of the electrochemical reaction, while the positive electrolyte and the positive electrode 28 may be respectively referred to as the anolyte and the anode of the electrochemical reaction. For simplicity, the terms “positive” and “negative” are used herein to refer to the electrodes, electrolytes, and electrode compartments in redox flow battery systems.

One example of a hybrid redox flow battery is an all-iron redox flow battery (IFB), in which the electrolyte includes iron ions in the form of iron salts (e.g., FeCl₂, FeCl₃, and the like), wherein the negative electrode 26 includes metal iron. For example, at the negative electrode 26, ferrous iron (Fe²⁺) gains two electrons and plates as iron metal (Fe⁰) onto the negative electrode 26 during battery charge, and Fe⁰ loses two electrons and re-dissolves as Fe²⁺ during battery discharge. At the positive electrode 28, Fe²⁺ loses an electron to form ferric iron (Fe³⁺) during battery charge, and Fe³⁺ gains an electron to form Fe²⁺ during battery discharge. The electrochemical reaction is summarized in equations (1) and (2), wherein the forward reactions (left to right) indicate electrochemical reactions during battery charge, while the reverse reactions (right to left) indicate electrochemical reactions during battery discharge:

Fe²⁺+2e⁻↔Fe⁰−0.44V (negative electrode) (1)

2Fe²⁺↔2Fe³⁺+2e⁻+0.77V(positive electrode) (2)

As discussed above, the negative electrolyte used in the IFB may provide a sufficient amount of Fe²⁺ so that, during battery charge, Fe²⁺ may accept two electrons from the negative electrode 26 to form Fe⁰ and plate onto a substrate. During battery discharge, the plated Fe⁰ may lose two electrons, ionizing into Fe²⁺ and dissolving back into the electrolyte. An equilibrium potential of the above reaction is −0.44 V and this reaction therefore provides a negative terminal for the desired system. On the positive side of the IFB, the electrolyte may provide Fe²⁺ during battery charge which loses an electron and oxidizes to Fe³⁺. During battery discharge, Fe³⁺ provided by the electrolyte becomes Fe²⁺ by absorbing an electron provided by the positive electrode 28. An equilibrium potential of this reaction is +0.77 V, creating a positive terminal for the desired system.

The IFB may provide the ability to charge and recharge electrolytes therein in contrast to other battery types utilizing non-regenerating electrolytes. Charge may be achieved by respectively applying an electric current across the electrodes 26 and 28 via terminals 40 and 42. The negative electrode 26 may be electrically coupled via the terminal 40 to a negative side of a voltage source so that electrons may be delivered to the negative electrolyte via the positive electrode 28 (e.g., as Fe²⁺ is oxidized to Fe³⁺ in the positive electrolyte in the positive electrode compartment 22). The electrons provided to the negative electrode 26 may reduce the Fe²⁺ in the negative electrolyte to form Fe⁰ at the (plating) substrate, causing the Fe²⁺ to plate onto the negative electrode 26.

Discharge may be sustained while Fe⁰ remains available to the negative electrolyte for oxidation and while Fe³⁺ remains available in the positive electrolyte for reduction. As an example, Fe³⁺ availability may be maintained by increasing a concentration or a volume of the positive electrolyte in the positive electrode compartment 22 side of the redox flow battery cell 18 to provide additional Fe³⁺ ions via an external source, such as an external positive electrolyte chamber 52. More commonly, availability of Fe⁰ during discharge may be an issue in IFB systems, wherein the Fe⁰ available for discharge may be proportional to a surface area and a volume of the negative electrode substrate, as well as to a plating efficiency. Charge capacity may be dependent on the availability of Fe²⁺ in the negative electrode compartment 20. As an example, Fe²⁺ availability may be maintained by providing additional Fe²⁺ ions via an external source, such as an external negative electrolyte chamber 50 to increase a concentration or a volume of the negative electrolyte to the negative electrode compartment 20 side of the redox flow battery cell 18.

In an IFB, the positive electrolyte may include ferrous iron, ferric iron, ferric complexes, or any combination thereof, while the negative electrolyte may include ferrous iron or ferrous complexes, depending on a state of charge (SOC) of the IFB system. As previously mentioned, utilization of iron ions in both the negative electrolyte and the positive electrolyte may allow for utilization of the same electrolytic species on both sides of the redox flow battery cell 18, which may reduce electrolyte cross-contamination and may increase the efficiency of the IFB system, resulting in less electrolyte replacement as compared to other redox flow battery systems.

Efficiency losses in an IFB may result from electrolyte crossover through a separator 24 (e.g., ion-exchange membrane barrier, microporous membrane, and the like). For example, Fe³⁺ ions in the positive electrolyte may be driven toward the negative electrolyte by a Fe³⁺ ion concentration gradient and an electrophoretic force across the separator 24. Subsequently, Fe³⁺ ions penetrating the separator 24 and crossing over to the negative electrode compartment 20 may result in coulombic efficiency losses. Fe³⁺ ions crossing over from the low pH redox side (e.g., more acidic positive electrode compartment 22) to the high pH plating side (e.g., less acidic negative electrode compartment 20) may result in precipitation of Fe(OH)₃. Precipitation of Fe(OH)₃ may degrade the separator 24 and cause permanent battery performance and efficiency losses. For example, Fe(OH); precipitate may chemically foul an organic functional group of an ion-exchange membrane or physically clog micropores of the ion-exchange membrane. In either case, due to the Fe(OH)₃ precipitate, membrane ohmic resistance may rise over time and battery performance may degrade. Precipitate may be removed by washing the IFB with acid, but constant maintenance and downtime may be disadvantageous for commercial battery applications. Furthermore, washing may be dependent on regular preparation of electrolyte, contributing to additional processing costs and complexity. Alternatively, adding specific organic acids to the positive electrolyte and the negative electrolyte in response to electrolyte pH changes may mitigate precipitate formation during battery charge and discharge cycling without driving up overall costs. Additionally, implementing a membrane barrier that inhibits Fe³⁺ ion crossover may also mitigate fouling.

Additional coulombic efficiency losses may be caused by reduction of H⁺ (e.g., protons) and subsequent formation of H₂ gas, and a reaction of protons in the negative electrode compartment 20 with electrons supplied at the plated iron metal of the negative electrode 26 to form H₂ gas.

The IFB electrolyte (e.g., FeCl₂, FeCl₃, FeSO₄, Fe₂(SO₄)₃, and the like) may be readily available and may be produced at low costs. In one example, the IFB electrolyte may be formed from ferrous chloride (FeCl₂), potassium chloride (KCl), manganese(II) chloride (MnCl₂), and boric acid (H₃BO₃). The IFB electrolyte may offer higher reclamation value because the same electrolyte may be used for the negative electrolyte and the positive electrolyte, consequently reducing cross-contamination issues as compared to other systems. Furthermore, because of iron's electron configuration, iron may solidify into a generally uniform solid structure during plating thereof on the negative electrode substrate. For zinc and other metals commonly used in hybrid redox batteries, solid dendritic structures may form during plating. A stable electrode morphology of the IFB system may increase the efficiency of the battery in comparison to other redox flow batteries. Further still, iron redox flow batteries may reduce the use of toxic raw materials and may operate at a relatively neutral pH as compared to other redox flow battery electrolytes. Accordingly, IFB systems may reduce environmental hazards as compared with all other current advanced redox flow battery systems in production.

Continuing with FIG. 1, a schematic illustration of the redox flow battery system 10 is shown. The redox flow battery system 10 may include the redox flow battery cell 18 fluidly coupled to an integrated multi-chambered electrolyte storage tank 110. The redox flow battery cell 18 may include the negative electrode compartment 20, separator 24, and positive electrode compartment 22. The separator 24 may include an electrically insulating ionic conducting barrier which prevents bulk mixing of the positive electrolyte and the negative electrolyte while allowing conductance of specific ions therethrough. For example, and as discussed above, the separator 24 may include an ion-exchange membrane and/or a microporous membrane.

The negative electrode compartment 20 may include the negative electrode 26, and the negative electrolyte may include electroactive materials. The positive electrode compartment 22 may include the positive electrode 28, and the positive electrolyte may include electroactive materials. In some examples, multiple redox flow battery cells 18 may be combined in series or in parallel to generate a higher voltage or electric current in the redox flow battery system 10.

Further illustrated in FIG. 1 are negative and positive electrolyte pumps 30 and 32, both used to pump electrolyte solution through the redox flow battery system 10. Electrolytes are stored in one or more tanks external to the cell, and are pumped via the negative and positive electrolyte pumps 30 and 32 through the negative electrode compartment 20 side and the positive electrode compartment 22 side of the redox flow battery cell 18, respectively.

The redox flow battery system 10 may also include a first bipolar plate 36 and a second bipolar plate 38, each positioned along a rear-facing side, e.g., opposite of a side facing the separator 24, of the negative electrode 26 and the positive electrode 28, respectively. The first bipolar plate 36 may be in contact with the negative electrode 26 and the second bipolar plate 38 may be in contact with the positive electrode 28. In other examples, however, the bipolar plates 36 and 38 may be arranged proximate but spaced away from the electrodes 26 and 28 and housed within the respective electrode compartments 20 and 22. In either case, the bipolar plates 36 and 38 may be electrically coupled to the terminals 40 and 42, respectively, either via direct contact therewith or through the negative and positive electrodes 26 and 28, respectively. The IFB electrolytes may be transported to reaction sites at the negative and positive electrodes 26 and 28 by the first and second bipolar plates 36 and 38, resulting from conductive properties of a material of the bipolar plates 36 and 38. Electrolyte flow may also be assisted by the negative and positive electrolyte pumps 30 and 32, facilitating forced convection through the redox flow battery cell 18. Reacted electrochemical species may also be directed away from the reaction sites by a combination of forced convection and a presence of the first and second bipolar plates 36 and 38.

As illustrated in FIG. 1, the redox flow battery cell 18 may further include the negative battery terminal 40 and the positive battery terminal 42. When a charge current is applied to the battery terminals 40 and 42, the positive electrolyte may be oxidized (loses one or more electrons) at the positive electrode 28, and the negative electrolyte may be reduced (gains one or more electrons) at the negative electrode 26. During battery discharge, reverse redox reactions may occur on the electrodes 26 and 28. In other words, the positive electrolyte may be reduced (gains one or more electrons) at the positive electrode 28, and the negative electrolyte may be oxidized (loses one or more electrons) at the negative electrode 26. An electrical potential difference across the battery may be maintained by the electrochemical redox reactions in the positive electrode compartment 22 and the negative electrode compartment 20, and may induce an electric current through a current collector while the reactions are sustained. An amount of energy stored by a redox battery may be limited by an amount of electroactive material available in electrolytes for discharge, depending on a total volume of electrolytes and a solubility of the electroactive materials.

The redox flow battery system 10 may further include the integrated multi-chambered electrolyte storage tank 110. The multi-chambered electrolyte storage tank 110 may be divided by a bulkhead 98. The bulkhead 98 may create multiple chambers within the multi-chambered electrolyte storage tank 110 so that both the positive and negative electrolytes may be included within a single tank. The negative electrolyte chamber 50 holds negative electrolyte including the electroactive materials, and the positive electrolyte chamber 52 holds positive electrolyte including the electroactive materials. The bulkhead 98 may be positioned within the multi-chambered electrolyte storage tank 110 to yield a desired volume ratio between the negative electrolyte chamber 50 and the positive electrolyte chamber 52. In one example, the bulkhead 98 may be positioned to set a volume ratio of the negative and positive electrolyte chambers 50 and 52 according to a stoichiometric ratio between the negative and positive redox reactions. FIG. 1 further illustrates a fill height 112 of the multi-chambered electrolyte storage tank 110, which may indicate a liquid level in each tank compartment. FIG. 1 also shows a gas head space 90 located above the fill height 112 of the negative electrolyte chamber 50, and a gas head space 92 located above the fill height 112 of the positive electrolyte chamber 52. The gas head space 92 may be utilized to store H₂ gas generated through operation of the redox flow battery (e.g., due to proton reduction and iron corrosion side reactions) and conveyed to the multi-chambered electrolyte storage tank 110 with returning electrolyte from the redox flow battery cell 18. The H₂ gas may be separated spontaneously at a gas-liquid interface (e.g., the fill height 112) within the multi-chambered electrolyte storage tank 110, thereby precluding having additional gas-liquid separators as part of the redox flow battery system 10. Once separated from the electrolyte, the H₂ gas may fill the gas head spaces 90 and 92. As such, the stored H₂ gas may aid in purging other gases from the multi-chambered electrolyte storage tank 110, thereby acting as an inert gas blanket for reducing oxidation of electrolyte species, which may help to reduce redox flow battery capacity losses. In this way, utilizing the integrated multi-chambered electrolyte storage tank 110 may forego having separate negative and positive electrolyte storage tanks, hydrogen storage tanks, and gas-liquid separators common to conventional redox flow battery systems, thereby simplifying a system design, reducing a physical footprint of the redox flow battery system 10, and reducing system costs.

FIG. 1 also shows a spillover hole 96, which may create an opening in the bulkhead 98 between the gas head spaces 90 and 92, and may provide a means of equalizing gas pressure between the chambers 50 and 52. The spillover hole 96 may be positioned at a threshold height above the fill height 112. The spillover hole 96 may further enable a capability to self-balance the electrolytes in each of the negative and positive electrolyte chambers 50 and 52 in the event of a battery crossover. In the case of an all-iron redox flow battery system, the same electrolyte (Fe²⁺) is used in both negative and positive electrode compartments 20 and 22, so spilling over of electrolyte between the negative and positive electrolyte chambers 50 and 52 may reduce overall system efficiency, but overall electrolyte composition, battery module performance, and battery module capacity may be maintained. Flange fittings may be utilized for all piping connections for inlets and outlets to and from the multi-chambered electrolyte storage tank 110 to maintain a continuously pressurized state without leaks. The multi-chambered electrolyte storage tank 110 may include at least one outlet from each of the negative and positive electrolyte chambers 50 and 52, and at least one inlet to each of the negative and positive electrolyte chambers 50 and 52. As one example, the at least one inlet to each of the negative and positive electrolyte chamber 50 and 52 may include a radial mixing manifold for mixing the returned electrolyte with the remaining electrolyte in the each of the negative and positive electrolyte chambers. Details of the radial mixing manifold are discussed further below with respect to FIGS. 2-4. Furthermore, one or more outlet connections may be provided from the gas head spaces 90 and 92 for directing H₂ gas to rebalancing reactors 80 and 82.

Although not shown in FIG. 1, the integrated multi-chambered electrolyte storage tank 110 may further include one or more heaters thermally coupled to each of the negative electrolyte chamber 50 and the positive electrolyte chamber 52. In alternate examples, only one of the negative and positive electrolyte chambers 50 and 52 may include one or more heaters. In the case where only the positive electrolyte chamber 52 includes one or more heaters, the negative electrolyte may be heated by transferring heat generated at the redox flow battery cell 18 to the negative electrolyte. In this way, the redox flow battery cell 18 may heat and facilitate temperature regulation of the negative electrolyte. The one or more heaters may be actuated by a controller 88 to regulate a temperature of the negative electrolyte chamber 50 and the positive electrolyte chamber 52 independently or together. For example, in response to an electrolyte temperature decreasing below a threshold temperature, the controller 88 may increase a power supplied to one or more heaters so that a heat flux to the electrolyte may be increased. The electrolyte temperature may be indicated by one or more temperature sensors mounted at the multi-chambered electrolyte storage tank 110, such as sensors 60 and 62. As examples, the one or more heaters may include coil type heaters or other immersion heaters immersed in the electrolyte fluid, or surface mantle type heaters that transfer heat conductively through the walls of the negative and positive electrolyte chambers 50 and 52 to heat the fluid therein. Other known types of tank heaters may be employed without departing from the scope of the present disclosure. Furthermore, the controller 88 may deactivate the one or more heaters in the negative and positive electrolyte chambers 50 and 52 in response to a liquid level decreasing below a solids fill threshold level. Said in another way, in some examples, the controller 88 may activate the one or more heaters in the negative and positive electrolyte chambers 50 and 52 only in response to a liquid level increasing above the solids fill threshold level. In this way, activating the one or more heaters without sufficient liquid in the negative and/or positive electrolyte chambers 50, 52 may be averted, thereby reducing a risk of overheating or burning out the heater(s).

Further still, one or more inlet connections may be provided to each of the negative and positive electrolyte chambers 50 and 52 from a field hydration system (not shown). In this way, the field hydration system may facilitate commissioning of the redox flow battery system 10, including installing, filling, and hydrating the redox flow battery system 10, at an end-use location. Furthermore, prior to commissioning the redox flow battery system 10 at the end-use location, the redox flow battery system 10 may be dry-assembled at a battery manufacturing facility different from the end-use location without filling and hydrating the redox flow battery system 10, before delivering the redox flow battery system 10 to the end-use location. In one example, the end-use location may correspond to a location where the redox flow battery system 10 is to be installed and utilized for on-site energy storage. Said another way, the redox flow battery system 10 may be designed such that, once installed and hydrated at the end-use location, a position of the redox flow battery system 10 may become fixed, and the redox flow battery system 10 may no longer be deemed a portable, dry system. Thus, from a perspective of an end-user, the dry, portable redox flow battery system 10 may be delivered on-site, after which the redox flow battery system 10 may be installed, hydrated, and commissioned. Prior to hydration, the redox flow battery system 10 may be referred to as a dry, portable system, the redox flow battery system 10 being free of or without water and wet electrolyte. Once hydrated, the redox flow battery system 10 may be referred to as a wet, non-portable system, the redox flow battery system 10 including wet electrolyte.

Further illustrated in FIG. 1, electrolyte solutions primarily stored in the multi-chambered electrolyte storage tank 110 may be pumped via the negative and positive electrolyte pumps 30 and 32 throughout the redox flow battery system 10. Electrolyte stored in the negative electrolyte chamber 50 may be pumped via the negative electrolyte pump 30 through the negative electrode compartment 20 side of the redox flow battery cell 18, and electrolyte stored in the positive electrolyte chamber 52 may be pumped via the positive electrolyte pump 32 through the positive electrode compartment 22 side of the redox flow battery cell 18.

The electrolyte rebalancing reactors 80 and 82 may be connected in line or in parallel with the recirculating flow paths of the electrolyte at the negative and positive sides of the redox flow battery cell 18, respectively, in the redox flow battery system 10. One or more rebalancing reactors may be connected in-line with the recirculating flow paths of the electrolyte at the negative and positive sides of the battery, and other rebalancing reactors may be connected in parallel, for redundancy (e.g., a rebalancing reactor may be serviced without disrupting battery and rebalancing operations) and for increased rebalancing capacity. In one example, the electrolyte rebalancing reactors 80 and 82 may be placed in a return flow path from the negative and positive electrode compartments 20 and 22 to the negative and positive electrolyte chambers 50 and 52, respectively.

The electrolyte rebalancing reactors 80 and 82 may serve to rebalance electrolyte charge imbalances in the redox flow battery system 10 occurring due to side reactions, ion crossover, and the like, as described herein. In one example, electrolyte rebalancing reactors 80 and 82 may include trickle bed reactors, where the H₂ gas and electrolyte may be contacted at catalyst surfaces in a packed bed for carrying out the electrolyte rebalancing reaction. In other examples, the rebalancing reactors 80 and 82 may include flow-through type reactors that are capable of contacting the H₂ gas and the electrolyte liquid and carrying out the electrolyte rebalancing reactions absent a packed catalyst bed.

During operation of the redox flow battery system 10, sensors and probes may monitor and control chemical properties of the electrolyte such as electrolyte pH, concentration, SOC, and the like. For example, as illustrated in FIG. 1, sensors 62 and 60 maybe be positioned to monitor positive electrolyte and negative electrolyte conditions at the positive electrolyte chamber 52 and the negative electrolyte chamber 50, respectively. In another example, sensors 62 and 60 may each include one or more electrolyte level sensors to indicate a level of electrolyte in the positive electrolyte chamber 52 and the negative electrolyte chamber 50, respectively. As another example, sensors 72 and 70, also illustrated in FIG. 1, may monitor positive electrolyte and negative electrolyte conditions at the positive electrode compartment 22 and the negative electrode compartment 20, respectively. The sensors 72 and 70 may be pH probes, optical probes, pressure sensors, voltage sensors, etc. It will be appreciated that sensors may be positioned at other locations throughout the redox flow battery system 10 to monitor electrolyte chemical properties and other properties.

For example, a sensor may be positioned in an external acid tank (not shown) to monitor acid volume or pH of the external acid tank, wherein acid from the external acid tank may be supplied via an external pump (not shown) to the redox flow battery system 10 in order to reduce precipitate formation in the electrolytes. Additional external tanks and sensors may be installed for supplying other additives to the redox flow battery system 10. For example, various sensors including, temperature, conductivity, and level sensors of a field hydration system may transmit signals to the controller 88. Furthermore, the controller 88 may send signals to actuators such as valves and pumps of the field hydration system during hydration of the redox flow battery system 10. Sensor information may be transmitted to the controller 88 which may in turn actuate the pumps 30 and 32 to control electrolyte flow through the redox flow battery cell 18, or to perform other control functions, as an example. In this manner, the controller 88 may be responsive to one or a combination of sensors and probes.

The redox flow battery system 10 may further include a source of H₂ gas. In one example, the source of H₂ gas may include a separate dedicated hydrogen gas storage tank. In the example of FIG. 1. H₂ gas may be stored in and supplied from the integrated multi-chambered electrolyte storage tank 110. The integrated multi-chambered electrolyte storage tank 110 may supply additional H₂ gas to the positive electrolyte chamber 52 and the negative electrolyte chamber 50. The integrated multi-chambered electrolyte storage tank 110 may alternately supply additional H₂ gas to an inlet of the electrolyte rebalancing reactors 80 and 82. As an example, a mass flow meter or other flow controlling device (which may be controlled by the controller 88) may regulate flow of the H₂ gas from the integrated multi-chambered electrolyte storage tank 110. The integrated multi-chambered electrolyte storage tank 110 may supplement the H₂ gas generated in the redox flow battery system 10. For example, when gas leaks are detected in the redox flow battery system 10 or when a reduction reaction rate is too low at low hydrogen partial pressure, the H₂ gas may be supplied from the integrated multi-chambered electrolyte storage tank 110 in order to rebalance the SOC of the electroactive materials in the positive electrolyte and the negative electrolyte. As an example, the controller 88 may supply the H₂ gas from the integrated multi-chambered electrolyte storage tank 110 in response to a measured change in pH or in response to a measured change in SOC of an electrolyte or an electroactive material.

For example, an increase in pH of the negative electrolyte chamber 50, or the negative electrode compartment 20, may indicate that H₂ gas is leaking from the redox flow battery system 10 and/or that the reaction rate is too slow with the available hydrogen partial pressure, and the controller 88, in response to the pH increase, may increase a supply of H₂ gas from the integrated multi-chambered electrolyte storage tank 110 to the redox flow battery system 10. As a further example, the controller 88 may supply H₂ gas from the integrated multi-chambered electrolyte storage tank 110 in response to a pH change, wherein the pH increases beyond a first threshold pH or decreases beyond a second threshold pH. In the case of an IFB, the controller 88 may supply additional H₂ gas to increase a rate of reduction of Fe³⁺ ions and a rate of production of protons, thereby reducing the pH of the positive electrolyte. Furthermore, the pH of the negative electrolyte may be lowered by hydrogen reduction of Fe³⁺ ions crossing over from the positive electrolyte to the negative electrolyte or by protons, generated at the positive side, crossing over to the negative electrolyte due to a proton concentration gradient and electrophoretic forces. In this manner, the pH of the negative electrolyte may be maintained within a stable region, while reducing the risk of precipitation of Fe³⁺ ions (crossing over from the positive electrode compartment 22) as Fe(OH)₃.

Other control schemes for controlling a supply rate of H₂ gas from the integrated multi-chambered electrolyte storage tank 110 responsive to a change in an electrolyte pH or to a change in an electrolyte SOC, detected by other sensors such as an oxygen-reduction potential (ORP) meter or an optical sensor, may be implemented. Further still, the change in pH or SOC triggering action of the controller 88 may be based on a rate of change or a change measured over a time period. The time period for the rate of change may be predetermined or adjusted based on time constants for the redox flow battery system 10. For example, the time period may be reduced if a recirculation rate is high, and local changes in concentration (e.g., due to side reactions or gas leaks) may quickly be measured since the time constants may be small.

The controller 88 may further execute control schemes based on an operating mode of the redox flow battery system 10. For example, the controller 88 may control charging and discharging of the redox flow battery cell 18 so as to cause iron preformation at the negative electrode 26 during system conditioning (where system conditioning may include an operating mode employed to optimize electrochemical performance of the redox flow battery system 10 outside of battery cycling). That is, during system conditioning, the controller 88 may adjust one or more operating conditions of the redox flow battery system 10 to plate iron metal on the negative electrode 26 to improve a battery charge capacity during subsequent battery cycling (thus, the iron metal may be preformed for battery cycling). The controller 88 may further execute electrolyte rebalancing as discussed above to rid the redox flow battery system 10 of excess hydrogen gas and reduce Fe³⁺ ion concentration. In this way, preforming iron at the negative electrode 26 and running electrolyte rebalancing during the system conditioning may increase an overall capacity of the redox flow battery cell 18 during battery cycling by mitigating iron plating loss. As used herein, battery cycling (also referred to as “charge cycling”) may include alternating between a charging mode and a discharging mode of the redox flow battery system 10.

It will be appreciated that all components apart from the sensors 60 and 62 and the integrated multi-chambered electrolyte storage tank 110 (and components included therein) may be considered as being included in a power module 120. As such, the redox flow battery system 10 may be described as including the power module 120 fluidly coupled to the integrated multi-chambered electrolyte storage tank 110 and communicably coupled to the sensors 60 and 62. In some examples, each of the power module 120 and the multi-chambered electrolyte storage tank 110 may be included in a single housing (not shown), such that the redox flow battery system 10 may be contained as a single unit in a single location. It will further be appreciated the positive electrolyte, the negative electrolyte, the sensors 60 and 62, the electrolyte rebalancing reactors 80 and 82, and the integrated multi-chambered electrolyte storage tank 110 (and components included therein) may be considered as being included in an electrolyte subsystem 130. As such, the electrolyte subsystem 130 may supply one or more electrolytes to the redox flow battery cell 18 (and components included therein).

As described above, mixing of electrolyte within an electrolyte chamber (such as positive electrolyte chamber 52 and negative electrolyte chamber 50 of FIG. 1) may be demanded for optimal performance a redox flow battery system such as redox flow battery system 10. Addition of powered stirrers to the electrolyte chamber may be not be desired due to an additional parasitic power draw from the stirrers. Instead a passive system may be desired based on flow of electrolyte into the electrolyte chamber from ta redox flow battery cell as driven by pumps (e.g., pumps 30 and 32 of FIG. 1). Previous passive mixing systems have included an axially positioned mixing manifold. However, the axially positioned mixing manifold may demand a minimum threshold amount of electrolyte in the electrolyte chamber before effective mixing. Additionally, the axially positioned mixing manifold may include a T-junction which increases a pipe loss and limits a type of material forming the mixing manifold. A radial mixing manifold may enhance mixing within the electrolyte tank and may not demand a minimum threshold amount of electrolyte. Further, the radial mixing manifold may not include a T-junction, thereby reducing the pipe loss and increasing options for material forming the mixing manifold.

Referring now to FIG. 2, an example schematic of a cylindrical multi-chambered electrolyte storage tank 200 including a radial mixing manifold 202 is shown. Herein cylindrical multi-chambered electrolyte storage tank 200 may also be referred to as multi-chambered electrolyte storage tank 200. Also shown in FIG. 2 is a coordinate system 201 including an x-axis, y-axis, and z-axis. The y-axis may be parallel to a gravitational axis 203 where gravity generates a downward force toward the bottom of the figure. Multi-chambered electrolyte storage tank 200 may be oriented with a radial axis parallel to the gravitational axis. Additionally, multi-chambered electrolyte storage tank 200 may be similar to multi-chambered electrolyte storage tank 110 of FIG. 1. Multi-chambered electrolyte storage tank 200 is shown as a non-limiting example of a liquid tank which may incorporate at least one radial mixing manifold 202. For example, radial mixing manifold may be included in a single cylindrical electrolyte chamber or a tank holding a different liquid.

FIG. 2 shows a cutaway view of a first electrolyte chamber 214. Multi-chambered electrolyte storage tank 200 may also include a second electrolyte chamber 212, divided from and fluidly decoupled from first electrolyte chamber 214 by a bulkhead 210. Bulkhead 210 may be similar to bulkhead 98 described above with respect to FIG. 1. Bulkhead 210 may include a spillover hole (not shown) positioned at a top of bulkhead 210 (e.g., along the y-axis) to allow gas to flow between first electrolyte chamber 214 and second electrolyte chamber 212. Electrolyte may fill first electrolyte chamber 214 up to a maximum electrolyte level 216. A gas head space 218 may occupy an internal volume of multi-chambered electrolyte storage tank 200 vertically above fill line 216. Gas head space 218 may be similar to gas head space 90 or gas head space 92 as described above with respect to FIG. 1. Multi-chambered electrolyte storage tank 200 may include a first gas flange 226. Gas flange 226 may fluidly couple gas head space 218 with a rebalancing reactor such as rebalancing reactors 80 or 82 of FIG. 1. Similarly, second electrolyte chamber 212 may include a second gas flange 222 configured to couple a gas head space of second electrolyte chamber 212 to the rebalancing reactor.

First electrolyte chamber 214 may include a first radial mixing manifold 202a. Additionally, second electrolyte chamber 212 may include a second radial mixing manifold 202b. First radial mixing manifold 202a may be configured similarly to second radial mixing manifold 202b and each may include the same components. In some examples first electrolyte chamber 214 and second electrolyte chamber 212 may each include only one radial mixing manifold 202. In one example, radial mixing manifold 202 may be configured to deliver electrolyte from an electrode compartment of the redox flow battery to an electrolyte chamber of the multi-chambered electrolyte storage tank 200. Herein first radial mixing manifold 202a may be discussed together with second radial mixing manifold 202b as radial mixing manifold 202, unless otherwise indicated.

Radial mixing manifold 202 may include a flange 208 positioned on an external surface of the first electrolyte chamber 214 of multi-chambered electrolyte storage tank 200. As one example, flange 208 may be positioned towards a vertical top (e.g., along the y-axis) surface of multi-chambered electrolyte storage tank 200. Additionally, flange 208 may be positioned on a top outer surface and spaced away from a vertical apex (e.g., with respect to y-axis/gravitational axis) of multi-chambered electrolyte storage tank 200 as indicated by line 231. Flange 208 may hermetically seal to a pipe delivering electrolyte from an electrolyte cell of a redox flow battery system (e.g., redox flow battery system 10 of FIG. 1), thereby maintaining a pressurization of multi-chambered electrolyte storage tank 200. Flange 208 may be tilted with respect to dashed line 232 parallel with the y-axis. In this way, a bottom (with respect to the y-axis) of flange 208 may be flush and in face sharing contact with the outer surface of multi-chambered electrolyte storage tank 200.

Radial mixing manifold 202 may further include manifold 204. Manifold 204 may extend from flange 208 through an inner volume of multi-chambered electrolyte storage tank 200. A portion of a top wall of multi-chambered electrolyte storage tank 200 may be missing where flange 208 meets manifold 204, thereby allowing liquid to flow through an internal diameter of flange 208 and into manifold 204. A top end (with respect to gravity) of manifold 204 is in face sharing contact with a bottom end of flange 208. In one example, flange 208 may receive electrolyte from a first electrode compartment or a second electrode compartment (e.g., negative electrode compartment 20 or positive electrode compartment 22 of FIG. 1). A length of manifold 204 may extend from a first inner edge of multi-chambered electrolyte storage tank 200 (not shown in FIG. 2) to a second inner edge 228 of multi-chambered electrolyte storage tank 200. In one example, the length of manifold 204 is equal to a diameter of the multi-chambered electrolyte storage tank 200. The first inner edge may be directly opposite the external edge of multi-chambered electrolyte storage tank 200 to which flange 208 is coupled. Second inner edge 228 may be vertically below first inner edge along the y-axis. Additionally, second inner edge 228 may be laterally offset from the first inner edge along the z-axis. In this way radial mixing manifold 202 may be tilted at an angle 230 between dashed line 232 parallel with the y-axis (vertical) and a central axis of radial mixing manifold 202 shown by dashed line 234 (looking along the x-axis). Angle 230 may be between +45° and −45°. Second inner edge 228 may be offset from being directly vertically beneath first inner edge to the left or right (in the z-direction) and up or down (y-axis, vertical axis) looking along the x-axis. In some examples, angle 230 may be the same for first radial mixing manifold 202a and second radial mixing manifold 202b. In other examples, angle 230 may be different for each of first radial mixing manifold 202a and second radial mixing manifold 202b. Additionally, a bottom end of manifold 204 may be physically coupled to and supported by second inner edge 228. A portion of the bottom end of manifold 204 within box 220 may be described further below with respect to FIG. 3.

Radial mixing manifold 202 may include a plurality of openings 206 (e.g., openings 206). Openings 206 may pass through a wall of manifold 204, thereby fluidly coupling manifold 204 to first electrolyte chamber 214. Openings 206 may be positioned dispersed along the wall of manifold 204. A number and position of openings 206 dispersed along the wall of manifold 204 may be chosen to optimize flow distribution and mixing of electrolyte within first electrolyte chamber 214. In some embodiments openings 206 may be circular openings however other shapes of openings 206 are possible and have been considered. In one example, fill line 216 may be a maximum electrolyte level inside multi-chambered electrolyte storage tank 200 and at least one of openings 206 may be positioned above fill line 216. In one example, opening 206 may include projections configured to further project liquid out into first electrolyte chamber 214.

In some examples, manifold 204 may include nozzles 502 circumferentially surrounding opening 206 at a first end and protruding into a cylindrical electrolyte chamber, such as first electrolyte chamber 214, at a second end, as shown in view 500 in FIG. 5. View 500 shows a cross sectional view in the y-z plane of a portion of manifold 204 between the first inner edge and second inner edge 228. Nozzles 502 may include a first orthogonal nozzle 502a positioned orthogonal with respect to central lateral axis 234. Nozzles 502 may further include a second upward nozzle 502b tilted upward with respect to the central lateral axis 234. Additionally or alternatively, nozzles 502 may include a third downward nozzle 502c tilted downward with respect to central lateral axis 234. In this way, electrolyte flowing through manifold 204 and out of nozzles 502 may be directed in multiple directions simultaneously, thereby enhancing a mixing of the electrolyte. Additionally, nozzles 502 may be articulated such that a user may adjust the angles of nozzles 502 with respect to central lateral axis 234. In some examples where pumps moving the electrolyte are configured to push against backpressure, nozzles 502 may be tapered about the second end. In this way, flow of electrolyte may be further adjusted or optimized as needed.

Returning now to FIG. 2, radial mixing manifold 202 may be positioned axially closer to bulkhead 210 than to an axial end (e.g., along the x-axis) of multi-chambered electrolyte storage tank 200. However, other axial positions of mixing manifold have been considered within the scope of this disclosure. The number and position of openings 206 may be adjusted based on the axial position of radial mixing manifold 202 within multi-chambered electrolyte storage tank 200.

Radial mixing manifold 202 may not include a T-shaped portion or a fluid T-junction in manifold 204 positioned inside a cylindrical electrolyte chamber such as first electrolyte chamber 214, and may be therefore formed of a material such as fiberglass. Said another way, radial mixing manifold may be only coupled to the cylindrical electrolyte chamber at the first inner edge and the second inner edge. In an example where radial mixing manifold 202 is formed of fiberglass, the fiberglass radial mixing manifold may be layered up and formed into the inner wall of multi-chambered electrolyte storage tank 200. In some examples, the material forming radial mixing manifold 202 may be a rigid material (e.g., not flexible). The material forming radial mixing manifold 202 may be chosen to enable facile bonding between radial mixing manifold 202 and walls of multi-chambered electrolyte storage tank 200. In alternate examples, radial mixing manifold 202 is formed of PVC and may be affixed to an inner wall of multi-chambered electrolyte storage tank 200 with epoxy.

Turning now to FIG. 3, a side view 300 including a portion of multi-chambered electrolyte storage tank 200 and radial mixing manifold 202 within box 220 of FIG. 2 is shown. Side view 300 may include second inner edge 228 of multi-chambered electrolyte storage tank 200. Multi-chambered electrolyte storage tank 200 may be cylindrical, but the curvature may be large with respect to the portion of second inner edge 228 shown in side view 300, such that in the view it is relatively flat. A bottom surface 304 of manifold 204 may be coupled to second inner edge 228 of multi-chambered electrolyte storage tank 200. In one example the parts of bottom surface 304 of manifold 204 may be in direct face sharing contact with second inner edge 228. Bottom surface 304 of manifold 204 may include at least one bottom opening 306. In one example, the at least one bottom opening 306 may be shaped as a semi-circle. A portion of an outer circumference defining bottom opening 306 may be formed by second inner edge 228. The at least one bottom opening 306 may be positioned on a downward side of manifold 204. The downward side of manifold 204 may be a circumferential portion of manifold 204 facing towards an axial center of multi-chambered electrolyte storage tank 200 (e.g., to a right of dashed line 234 as shown in FIG. 3). Further, the at least one bottom opening may be positioned at a lowest (e.g., with respect to gravity) point of manifold 204 and orthogonal to line 234. In some examples, manifold 204 may include more than one bottom opening 306. Additionally, a shape of bottom opening 306 may be the same or different from a shape of openings 206. In this way, gravity may at least assist in forcing all electrolyte to completely drain from manifold 204 into first electrolyte chamber 214. Said another way, bottom opening 206 may prevent electrolyte from being trapped within manifold 204.

Turning now to FIG. 6, a cut-away view of a multi-chambered electrolyte storage tank 600 including an alternate embodiment of a radial mixing manifold 602 is shown. Multi-chambered electrolyte storage tank 600 may include components such as a bulkhead 210 and first electrolyte chamber 214 that are discussed with respect to multi-chambered electrolyte storage tank 200 of FIG. 2. Such components are labeled similarly and will not be reintroduced. Additionally, radial mixing manifold 602 is shown included in first electrolyte chamber 214. Radial mixing manifold 602 may additionally or alternatively be included in second electrolyte chamber 212.

Radial mixing manifold 602 may include a flange 608 and a manifold 604. Flange 608 may be positioned external to first electrolyte chamber 214 of multi-chambered electrolyte storage tank 200. As one example, flange 608 may be positioned towards a vertical top (e.g., along the y-axis) surface of multi-chambered electrolyte storage tank 200. Additionally, flange 608 may be positioned at least partially on a top outer surface and spaced away from a vertical apex (e.g., with respect to y-axis/gravitational axis) of multi-chambered electrolyte storage tank 600 as indicated by line 231. Flange 608 may be positioned parallel to the y-axis and may not be flush to a curved external surface of first electrolyte chamber 214. Flange 608 may hermetically seal at a top (with respect to the gravitational axis) end to a pipe delivering electrolyte from an electrolyte cell of a redox flow battery system (e.g., redox flow battery system 10 of FIG. 1), thereby maintaining a pressurization of multi-chambered electrolyte storage tank 200.

Flange 608 may be fluidly coupled at a bottom end to manifold 604. Manifold 604 may extend vertically from flange 608. Additionally, radial mixing manifold 602 may be off center to a diameter of multi-chambered electrolyte storage tank 600. In this way, radial mixing manifold 602 may be parallel to the y-axis and may be positioned as a secant with respect to the curved wall of multi-chambered electrolyte storage tank 600. Manifold 604 may extend through a wall of multi-chambered electrolyte storage tank 600 and include a top section 604a positioned external to the wall and a bottom section 604b positioned internal to the wall. Top section 604a may be in face sharing contact with flange 608. The manifold 604 may be coupled to an inner surface of multi-chambered electrolyte storage tank 600 at a first inner edge 610 and may extend through a cutout of multi-chambered electrolyte storage tank 600, thereby allowing fluid to flow through flange 608 and manifold 604 into an interior of first electrolyte chamber 214. A bottom end 606 (e.g., bottom opening) of bottom section 604b may be positioned vertically (e.g., with respect to the y-axis) above the maximum electrolyte level 216. In some examples, a portion of an outer edge of bottom end 606 of may contact an inner wall of multi-chambered electrolyte storage tank 600. Further, the portion of the bottom section 604b may be coupled to a second inner edge 612 of multi-chambered electrolyte storage tank 600. The second inner edge 612, directly vertically (e.g., along the y-axis) below first inner edge 610. In this way, electrolyte entering first electrolyte chamber 214 through radial mixing manifold 602 may be directed along the inner wall of multi-chambered electrolyte storage tank thereby directing a flow of the electrolyte circumferentially around the inner walls of the multi-chambered electrolyte storage tank 600. The flow of the electrolyte may follow a circular path, thereby mixing the electrolyte entering first electrolyte chamber 214.

Turning now to FIG. 4, a method 400 is shown for mixing liquid in a liquid tank using a radial mixing manifold, such a radial mixing manifold 202 described above with respect to FIGS. 2-3B or radial mixing manifold 602 described above with respect to FIG. 6. In one example, the liquid may be an electrolyte and the liquid tank may be an electrolyte chamber such as first electrolyte chamber 214 or second electrolyte chamber 212 of a multi-chambered electrolyte storage tank 200 or multi-chambered electrolyte storage tank 600 as described above with respect to FIG. 2 and FIG. 6 respectively. Additionally, the multi-chambered electrolyte storage tank may be included in a redox flow battery system such as redox flow battery system 10 of FIG. 1. Method 400 may be at least partially carried out via a controller such as controller 88 of FIG. 1 and may be stored as executable instructions at a non-transitory storage medium (e.g., memory) communicably coupled to controller 88. Method 400 may be executed upon activation of the redox flow battery system.

At 402, method 400 includes activating a liquid pump. The liquid pump may be pump 30 or pump 32 of FIG. 1, and may be configured to pump liquid into the liquid tank. In one example, the liquid pump may be configured to pump electrolyte from a redox flow battery cell to an electrolyte chamber. Activating the liquid pump may occur as part of operating the redox flow battery system in a charging mode, a discharging mode, or an idle mode.

At 404, method 400 includes directing liquid into the liquid tank through the radial mixing manifold. In one example, the liquid may enter the tank through openings in the radial mixing manifold and not through other ports included in the liquid tank. In an alternate example, liquid may enter the tank through a bottom of a manifold of the radial mixing manifold. At 406, method 400 includes distrusting and mixing the liquid throughout the liquid tank. In one example liquid may fill an internal volume of the radial mixing manifold faster than the liquid can exit the radial mixing manifold through the openings. In this way, liquid may be distributed to the liquid tank, through each opening of the radial mixing manifold. Additionally, the pressure of liquid exiting the radial mixing manifold through the openings and/or nozzles positioned on the openings, may aid in mixing the liquid in the liquid tank. In an alternate embodiment, liquid exiting the bottom of the manifold may be directed along an inner wall of the liquid tank, thereby motivating a flow electrolyte in a circular motion along the wall of the liquid tank. Method 400 ends.

The technical effect of method 400 is to mix and distribute electrolyte entering an electrolyte storage chamber. In this way, liquid entering a liquid tank may be distributed and mixed as driven by a liquid pump. The liquid pump may be the same pump used for circulating electrolyte between an electrolyte chamber and a redox flow battery cell, thereby reducing a parasitic power demanded for mixing, such as additional impellers. Additionally, the radial mixing manifold may not include a T-junction, thereby reducing pipe loss and further reducing a power demand on the pumps. Further, a lack of T-junction expands a range of materials which may be used to form the radial mixing manifold.

The disclosure also provides support for a redox flow battery system, comprising: a cylindrical electrolyte chamber fluidly coupled to a redox flow battery cell, a radial mixing manifold fluidly coupled to the cylindrical electrolyte chamber and including a flange configured to receive electrolyte from the redox flow battery cell and a manifold configured to mix and distribute electrolyte within the cylindrical electrolyte chamber, and wherein the manifold extends from a first inner edge of the cylindrical electrolyte chamber to a second inner edge of the cylindrical electrolyte chamber, wherein the second inner edge is lower than the first inner edge, and, wherein the manifold includes a plurality of openings and at least one bottom opening positioned at the second inner edge. In a first example of the system, the cylindrical electrolyte chamber is oriented with a radial axis parallel to a gravitational axis. In a second example of the system, optionally including the first example, the second inner edge is offset from the first inner edge along a z-axis. In a third example of the system, optionally including one or both of the first and second examples, manifold is supported by the second inner edge. In a fourth example of the system, optionally including one or more or each of the first through third examples, the cylindrical electrolyte chamber includes only one radial mixing manifold. In a fifth example of the system, optionally including one or more or each of the first through fourth examples, the manifold extends straight from the first inner edge to the second inner edge and is not T-shaped inside the cylindrical electrolyte chamber. In a sixth example of the system, optionally including one or more or each of the first through fifth examples, the manifold does not include a fluid T-junction inside the cylindrical electrolyte chamber.

The disclosure also provides support for a redox flow battery system, comprising: a cylindrical electrolyte chamber, an electrode compartment fluidly coupled to the cylindrical electrolyte chamber, a radial mixing manifold configured to deliver electrolyte from the electrode compartment to the cylindrical electrolyte chamber, wherein the radial mixing manifold includes a flange and a manifold, and wherein the flange is spaced away from a vertical apex of the cylindrical electrolyte chamber, and, wherein the manifold extends from the flange to an inner surface the cylindrical electrolyte chamber and the radial mixing manifold is tilted at an angle from a line parallel to a gravitational axis, and wherein the manifold includes at least one bottom opening configured to allow electrolyte to drain out of the manifold. In a first example of the system, the angle of the manifold is between +45° and −45°. In a second example of the system, optionally including the first example, the manifold is tilted left of right in a z-direction. In a third example of the system, optionally including one or both of the first and second examples, the manifold is formed of rigid material. In a fourth example of the system, optionally including one or more or each of the first through third examples, the manifold further includes openings positioned dispersed along a wall of the manifold. In a fifth example of the system, optionally including one or more or each of the first through fourth examples, at least one of the openings includes a nozzle. In a sixth example of the system, optionally including one or more or each of the first through fifth examples, the at least one bottom opening is positioned at a lowest point of the manifold relative to gravity.

The disclosure also provides support for a method for operating a redox flow battery system, comprising: directing liquid from an electrode compartment of the redox flow battery system to through a radial mixing manifold and into a cylindrical electrolyte chamber of the redox flow battery system, wherein the radial mixing manifold includes a manifold positioned within the cylindrical electrolyte chamber and tilted at an angle with respect a gravitational axis, and wherein the manifold includes openings configured to distribute and mix liquid within the cylindrical electrolyte chamber, and at least one bottom opening formed at a bottom surface of the radial mixing manifold. In a first example of the method, the method further comprises: activating a liquid pump of the redox flow battery system to direct the liquid. In a second example of the method, optionally including the first example, activating the liquid pump occurs when the redox flow battery system is in a charging mode, a discharging mode, or an idle mode. In a third example of the method, optionally including one or both of the first and second examples, the at least one bottom opening is configured to drain the manifold of liquid. In a fourth example of the method, optionally including one or more or each of the first through third examples, a number and position of the openings are adjusted based on a position of the manifold within the cylindrical electrolyte chamber. In a fifth example of the method, optionally including one or more or each of the first through fourth examples, the radial mixing manifold includes a flange positioned on an external surface of the cylindrical electrolyte chamber and fluidly coupled to the manifold.

FIGS. 2-3 and 5-6 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. FIGS. 2-3 and 5-6 are drawn approximately to scale, although other dimensions or relative dimensions may be used.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A redox flow battery system, comprising:
a cylindrical electrolyte chamber fluidly coupled to a redox flow battery cell;
a radial mixing manifold fluidly coupled to the cylindrical electrolyte chamber and including a flange configured to receive electrolyte from the redox flow battery cell and a manifold configured to mix and distribute electrolyte within the cylindrical electrolyte chamber, and wherein the manifold extends from a first inner edge of the cylindrical electrolyte chamber to a second inner edge of the cylindrical electrolyte chamber, wherein the second inner edge is lower than the first inner edge, and;
wherein the manifold includes a plurality of openings and at least one bottom opening positioned at the second inner edge.

2. The redox flow battery system of claim 1, wherein the cylindrical electrolyte chamber is oriented with a radial axis parallel to a gravitational axis.

3. The redox flow battery system of claim 1, wherein the second inner edge is offset from the first inner edge along a z-axis.

4. The redox flow battery system of claim 1, wherein manifold is supported by the second inner edge.

5. The redox flow battery system of claim 1, wherein the cylindrical electrolyte chamber includes only one radial mixing manifold.

6. The redox flow battery system of claim 1, wherein the manifold extends straight from the first inner edge to the second inner edge and is not T-shaped inside the cylindrical electrolyte chamber.

7. The redox flow battery system of claim 1, wherein the manifold does not include a fluid T-junction inside the cylindrical electrolyte chamber.

8. A redox flow battery system, comprising:
a cylindrical electrolyte chamber;
an electrode compartment fluidly coupled to the cylindrical electrolyte chamber;
a radial mixing manifold configured to deliver electrolyte from the electrode compartment to the cylindrical electrolyte chamber, wherein the radial mixing manifold includes a flange and a manifold, and wherein the flange is spaced away from a vertical apex of the cylindrical electrolyte chamber, and;
wherein the manifold extends from the flange to an inner surface the cylindrical electrolyte chamber and the radial mixing manifold is tilted at an angle from a line parallel to a gravitational axis, and wherein the manifold includes at least one bottom opening configured to allow electrolyte to drain out of the manifold.

9. The redox flow battery system of claim 8, wherein the angle of the manifold is between +45° and −45°.

10. The redox flow battery system of claim 8, wherein the manifold is tilted left of right in a z-direction.

11. The redox flow battery system of claim 8, wherein the manifold is formed of rigid material.

12. The redox flow battery system of claim 8, wherein the manifold further includes openings positioned dispersed along a wall of the manifold.

13. The redox flow battery system of claim 12, wherein at least one of the openings includes a nozzle.

14. The redox flow battery system of claim 8, wherein the at least one bottom opening is positioned at a lowest point of the manifold relative to gravity.

15. A method for operating a redox flow battery system, comprising:
directing liquid from an electrode compartment of the redox flow battery system to through a radial mixing manifold and into a cylindrical electrolyte chamber of the redox flow battery system, wherein the radial mixing manifold includes a manifold positioned within the cylindrical electrolyte chamber and tilted at an angle with respect to a gravitational axis, and wherein the manifold includes openings configured to distribute and mix liquid within the cylindrical electrolyte chamber, and at least one bottom opening formed at a bottom surface of the radial mixing manifold.

16. The method of claim 15, further comprising activating a liquid pump of the redox flow battery system to direct the liquid.

17. The method of claim 16, wherein activating the liquid pump occurs when the redox flow battery system is in a charging mode, a discharging mode, or an idle mode.

18. The method of claim 15, wherein the at least one bottom opening is configured to drain the manifold of liquid.

19. The method of claim 15, wherein a number and position of the openings are adjusted based on a position of the manifold within the cylindrical electrolyte chamber.

20. The method of claim 15, wherein the radial mixing manifold includes a flange positioned on an external surface of the cylindrical electrolyte chamber and fluidly coupled to the manifold.
